(19) United States
(12) Patent Application Publication
(10) Pub. No.: US 2024/0418501 A1
(43) Pub. Date: Dec. 19, 2024

(54) OPTICAL SENSOR FOR FILM THICKNESS MEASUREMENT

(71) Applicant: Tokyo Electron Limited, Tokyo (JP)

(72) Inventors: Ivan MALEEV, Fremont, CA (US); Yan CHEN, Fremont, CA (US); Holger TUITJE, Fremont, CA (US); Basanta BHADURI, Fremont, CA (US); Ching Ling MENG, Sunnyvale, CA (US); Da SONG, Albany, NY (US); Xinkang TIAN, Fremont, CA (US)

(73) Assignee: Tokyo Electron Limited, Tokyo (JP)

(21) Appl. No.: 18/501,672

(22) Filed: Nov. 3, 2023

Related U.S. Application Data
(60) Provisional application No. 63/521,757, filed on Jun. 19, 2023.

(51) Int. Cl. G01B 11/06

(52) U.S. Cl. CPC G01B 11/0625

(57) ABSTRACT

A method of film thickness measurement includes illuminating a top layer of a sample in a first region with a broadband illumination beam. The sample includes a substrate and a plurality of semiconductor structures formed between the substrate and the top layer. A first reflectivity spectrum of the sample is obtained in the first region. A first thickness of the top layer in the first region is determined by applying a top-layer model to the first reflectivity spectrum. The top-layer model is substantially unaffected by the plurality of semiconductor structures.

### INCORPORATION BY REFERENCE

This present disclosure claims the benefit of U.S. Provisional Application No. 63/521,757, filed on Jun. 19, 2023, which is incorporated herein by reference in its entirety.

### FIELD OF THE INVENTION

This disclosure relates to a metrology apparatus and a method of film thickness measurement.

### BACKGROUND

In the manufacture of a semiconductor device (especially on the microscopic scale), various fabrication processes are executed such as film-forming depositions, etch mask creation, patterning, material etching and removal, and doping treatments. These processes are performed repeatedly to form desired semiconductor device elements on a substrate. Key to these processes are film thickness control and film uniformity control. Therefore, various film thickness characterization techniques have been developed and used in the semiconductor industry.

### SUMMARY

The present disclosure relates to a method of film thickness measurement and an apparatus.

According to a first aspect of the disclosure, a method of film thickness measurement is provided. The method includes illuminating a top layer of a sample in a first region with a broadband illumination beam. The sample includes a substrate and a plurality of semiconductor structures formed between the substrate and the top layer. A first reflectivity spectrum of the sample in the first region is obtained. A first thickness of the top layer in the first region is determined by applying a top-layer model to the first reflectivity spectrum. The top-layer model is substantially unaffected by the plurality of semiconductor structures.

In some embodiments, applying the top-layer model includes performing a Fourier Transform (FT) of the first reflectivity spectrum to obtain an FT spectrum. The first thickness is determined based on a primary peak of the FT spectrum which has a highest intensity in the FT spectrum.

In some embodiments, the FT is performed for at least a first portion of the first reflectivity spectrum substantially unaffected by the plurality of semiconductor structures. In some embodiments, the FT is performed for both the first portion and a second portion of the first reflectivity spectrum which is affected by the plurality of semiconductor structures. In some embodiments, the FT spectrum further includes a secondary peak that is affected by the plurality of semiconductor structures. The primary peak is substantially unaffected by the plurality of semiconductor structures. The first thickness is determined based on the primary peak of the FT spectrum and not based on the secondary peak so that the top-layer model is substantially unaffected by the plurality of semiconductor structures.

In some embodiments, prior to determining the first thickness of the top layer, a second portion of the first reflectivity spectrum is truncated that is affected by the plurality of semiconductor structures. In some embodiments, the first portion below a critical wavelength is truncated.

In some embodiments, a location of the primary peak of the FT spectrum versus the first thickness is calibrated experimentally or computationally. In some embodiments, a horizontal axis of the FT spectrum is scaled with n and k, which are complex refractive indices of the top layer, to obtain a scaled FT spectrum so that the location of the primary peak of the scaled FT spectrum is independent of n and k.

In some embodiments, obtaining the first reflectivity spectrum of the sample includes collecting at least two reflected beams of substantially orthogonal polarizations. The first reflectivity spectrum is obtained as a ratio of reflectivities collected at the at least two reflected beams. In some embodiments, a critical wavelength is determined at which the ratio starts to be different from unity.

In some embodiments, the first reflectivity spectrum of the sample is a reflectivity coefficient spectrum. A critical wavelength is determined that is a boundary between two regimes of the reflectivity coefficient spectrum.

In some embodiments, the sample, the broadband illumination beam, or a combination thereof is repositioned. The top layer of the sample is illuminated in a second region with the broadband illumination beam. A second reflectivity spectrum of the sample in the second region is obtained. A second thickness of the top layer in the second region is determined by applying the top-layer model to the second reflectivity spectrum. In some embodiments, a plurality of thicknesses of the top layer in a plurality of regions is determined, in an X-Y pattern or an R-θ pattern, across at least a fraction of the sample. In some embodiments, 5 to 100,000 thicknesses of the top layer are measured across a fraction or the entirety of the sample.

In some embodiments, the top layer includes a semiconductor material, and the broadband illumination beam has a wavelength range of 200-1000 nm.

In some embodiments, the top layer includes silicon.

According to a second aspect of the disclosure, an apparatus is provided. The apparatus includes a handling stage configured to receive a sample. The sample includes a substrate, a top layer and a plurality of semiconductor structures formed between the substrate and the top layer. A light source is configured to emit a broadband illumination beam. Optics are configured to guide the broadband illumination beam to illuminate the top layer of the sample, collect a reflected beam from the top layer and guide the reflected beam to an optical detector that is configured to obtain a reflectivity spectrum of the sample. A controller is configured to determine a thickness of the top layer by applying a top-layer model to the reflectivity spectrum. The top-layer model is substantially unaffected by the plurality of semiconductor structures.

In some embodiments, the optics include a Schwarzschild objective and a knife edge prism (KEP). The Schwarzschild objective includes a primary mirror and a secondary mirror. The KEP has a first side and a second side. The Schwarzschild objective and the KEP are configured so that the broadband illumination beam is directed by the first side of the KEP to go through an aperture of the primary mirror to the secondary mirror, reflected to the primary mirror, and then reflected to the top layer of the sample. The Schwarzschild objective and the KEP are configured so that the reflected beam from the top layer is reflected by the primary mirror to the secondary mirror, reflected to go through the aperture of the primary mirror to the second side of the KEP, and then directed to the optical detector.

In some embodiments, the optics includes at least one selected from the group consisting of an optical fiber, a collection lens, a system stop aperture, and a polarizer. In some embodiments, an orientation of the polarizer is capable of being switched between at least two substantially orthogonal orientations.

In some embodiments, the handling stage is an X-Y, X-Y-Z, R-θ, or R-θ-Z stage. The light source includes at least one selected from the group consisting of a laser, a laser diode, a light emitting diode, a gas discharge light source, and a laser-driven light source.

In some embodiments, the apparatus further includes a processing chamber configured to perform a surface treatment on the sample.

In some embodiments, the optical detector is a broadband high-resolution spectrometer.

According to a third aspect of the disclosure, a processing system is provided. The processing system includes a wafer processing module and an optical apparatus. The optical apparatus includes a handling stage configured to receive a sample. The sample includes a substrate, a top layer and a plurality of semiconductor structures formed between the substrate and the top layer. A light source is configured to emit a broadband illumination beam. Optics are configured to guide the broadband illumination beam to illuminate the top layer of the sample, collect a reflected beam from the top layer and guide the reflected beam to an optical detector that is configured to obtain a reflectivity spectrum of the sample. A controller is configured to determine a thickness of the top layer by applying a top-layer model to the reflectivity spectrum. The top-layer model is substantially unaffected by the plurality of semiconductor structures.

In some embodiments, the wafer processing module is configured to perform a surface treatment on the sample.

In some embodiments, the wafer processing module is configured to selectively removing a portion of the top layer of the sample.

In some embodiments, the controller is configured to communicate a wafer map including a plurality of top layer thickness measurements to the wafer processing module.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 shows a vertical cross-sectional view of a sample in accordance with some embodiments of the present disclosure.

FIG. 2 shows a flow chart of a process for film thickness measurements, in accordance with some embodiments of the present disclosure.

FIGS. 3A and 3B respectively show a schematic view and a perspective view of an apparatus in accordance with some embodiments of the present disclosure.

FIGS. 4A and 4B respectively show a reflectivity spectrum and an FT spectrum of 1 μm-thick Si layer on top of a thin SiO₂ layer on top of Si, in accordance with some embodiments of the present disclosure.

FIG. 5 shows a plot of critical wavelength versus top Si layer thickness above typical structures on a Si substrate, in accordance with some embodiments of the present disclosure.

FIG. 6 shows FT peak position versus top layer Si thickness on top of an arbitrary structure on top of a Si substrate, in accordance with some embodiments of the present disclosure.

FIG. 7 shows FT peak position versus top layer Si thickness on top of an arbitrary structure on top of a Si substrate, in accordance with some embodiments of the present disclosure.

FIG. 8 shows a spectrum of a reflectivity ratio of orthogonal polarizations Rₛ to Rₚ for a top Si layer on top of typical semiconductor structures on top of a Si wafer, in accordance with some embodiments of the present disclosure.

FIG. 9 shows a spectrum of a reflectivity ratio of polarized signals and spectral reflectivity for bare silicon and spectral reflectivity for a top silicon layer on top of typical semiconductor structures on top of a Si substrate, in accordance with some embodiments of the present disclosure.

FIG. 10 shows determination of spectral envelopes of a spectrum, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity's sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

In the drawings, like reference numerals designate identical or corresponding parts throughout the several views. Additionally, as used herein, the words “a”, “an” and the like generally carry a meaning of “one or more”, unless stated otherwise.

Furthermore, the terms, “approximately”, “approximate”, “about” and similar terms generally refer to ranges that include the identified value within a margin of 20%, 10%, or preferably 5%, and any values therebetween.

Thin film optical metrology is one of the cornerstones of semiconductor manufacturing processes. The current technology of choice is based on spectroscopic analysis of reflections from a thin film and includes spectroscopic reflectometry (SR) and ellipsometry (SE), both of which are widespread technologies due to best-in-class sensitivity, high throughput, reasonable cost, and non-destructive measurement capability. However, spectroscopic analysis normally requires information about and assumptions to be made about the layer stack and the structures formed on a wafer such that a multi-layer model of the sample structure can be built. Such a multi-layer model typically takes into consideration a top layer of interest and at least one underlying layer. The multi-layer model is then used to generate synthetic spectra, which can be compared to measured spectra such that parameters of interest such as film thickness can be determined. However, if information about layer thicknesses and structures formed within the layers is incomplete, then spectroscopic techniques may be unable to provide accurate measurement results. A similar disadvantage exists if optical properties of layers and structures are not known and/or difficult to obtain. Even with all necessary information available, it usually takes time and engineering effort to build and optimize a multi-layer model before one can be used for actual measurements. There is thus an unmet need for a technology that could measure thin film thickness with nanometer-level sensitivity with a top-layer model (or a single-layer model) that is not based on or not related to underlying layers and structures.

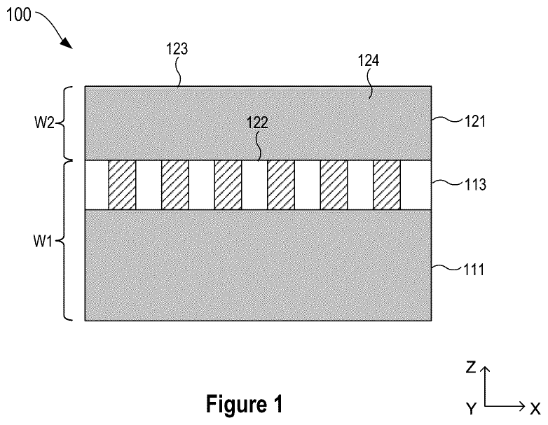

Techniques herein include an apparatus and a method for measuring a thickness of a top layer 121 formed on top of structures 113 formed on top of a substrate 111 in a sample 100 for example in FIG. 1. In one example, this type of structure (e.g. 100) may be formed by taking two semiconductor wafers W1 and W2 with at least one wafer (e.g. W1) having complex semiconductor structures (e.g. 113) fabricated thereupon, and binding them top to top or face to face, followed by thinning of one of the bonded wafers (e.g. W2) until only a thin Si layer (e.g. 121) remains on top of the structures 113. The objective is to measure the thickness of the remaining top Si layer (e.g. 121) across the sample 100 and to provide a map of Si layer thickness to semiconductor processing tools for subsequent processing. In another example, the sample 100 can be formed by depositing the top layer 121 over the structures 113.

Both the top layer 121 and the substrate 111 may include silicon (Si) but can also include other semiconductor materials typically used in semiconductor manufacturing. The structures 113 can include any circuit, transistor, metal/dielectric pattern, bonding interface and/or the like, as one skilled in the art would understand. For illustrative purposes, Si will be used as a non-limiting example for the top layer 121, and a line pattern will be used as a non-limiting example for the structures 113. Accordingly, the top layer 121 will also be referred to as a top Si layer 124.

One challenge to overcome is the lack of information about properties of the structures 113 below the top Si layer 124. Such properties may be either poorly defined or entirely unknown. Even if such properties are known, another challenge is to establish and optimize a robust multi-layer model. For example, a known circuit may be formed immediately below the top Si layer 124. However, it is challenging to build a multi-layer model involving the known circuit as conventional models typically assume a flat and uniform layer.

According to aspects of the present disclosure, a method described herein utilizes absorption properties of the top layer material, for example silicon (Si). An apparatus is used for measuring the spectral reflectivity of the top Si layer 124 upon broadband illumination, and the measured spectral dependence of absorption within the top Si layer 124 and reflection from the top Si layer 124 are used to determine the thickness of the top Si layer 124. In one embodiment, a spectroscopic reflectometer (SR) may be used to acquire such a reflectivity spectrum. Hereinafter, the spectroscopic reflectometer utilized for this method will be referred to as an absorption spectroscopic reflectometer (aSR).

Still referring to FIG. 1, spectral reflectivity acquired upon broadband illumination (as opposed to monochromatic illumination), from above, of the top Si layer 124 of FIG. 1 would, in general, be affected not only by properties of the top Si layer 124 whose thickness is to be determined, but also by properties of the underlying structures (e.g. 113 and 111). When a thin film (e.g. the top Si layer 124) is illuminated with broadband illumination, reflectivity spectra exhibit a characteristic periodicity due to constructive and destructive interference affecting the wavelengths of the illumination beam differently as they traverse the thin film (e.g. 124), reflect from a bottom surface 122, and traverse the thin film back towards the top surface 123. Semiconductor materials, such as Si, absorb a portion of the incoming broadband illumination, and light transparency generally increases with wavelength such that there is little absorption in the infrared (IR) part of the spectrum.

If, at some wavelength, absorption in the top Si layer 124 of FIG. 1 is sufficiently large to cause full attenuation of the illumination beam before it reaches the underlying structures (e.g. 113 and 111), then the reflectivity of the top Si layer 124 at that wavelength would substantially match the reflectivity of an identical Si layer without any underlying structures or any other films formed thereupon. The same is expected to be the case when a portion of the illuminating beam which may have reached the underlying structures (e.g. 113 and 111) is reflected by the underlying structures (e.g. 113) and is fully attenuated while the portion of the illuminating beam traverses the top Si layer 124 back towards the top surface 123.

Thus, because of the wavelength dependence of absorption in Si, it is expected that there would exist a portion of the reflectivity spectrum where absorption is sufficiently high, and therefore the reflectivity spectrum of the top Si layer 124 with underlying features will substantially match a reflectivity spectrum of an identical Si layer without any underlying structures or any other films formed thereunder. Conversely, for wavelengths outside of this portion of the reflectivity spectrum, said spectrum would differ due to lack of sufficient attenuation, and exhibit the periodicity characteristic of thin film reflectivity spectra. This periodicity may potentially be further altered by the underlying structures diffracting a portion of the illumination beam at still longer wavelengths, thus altering the periodicity characteristic of a thin film alone.

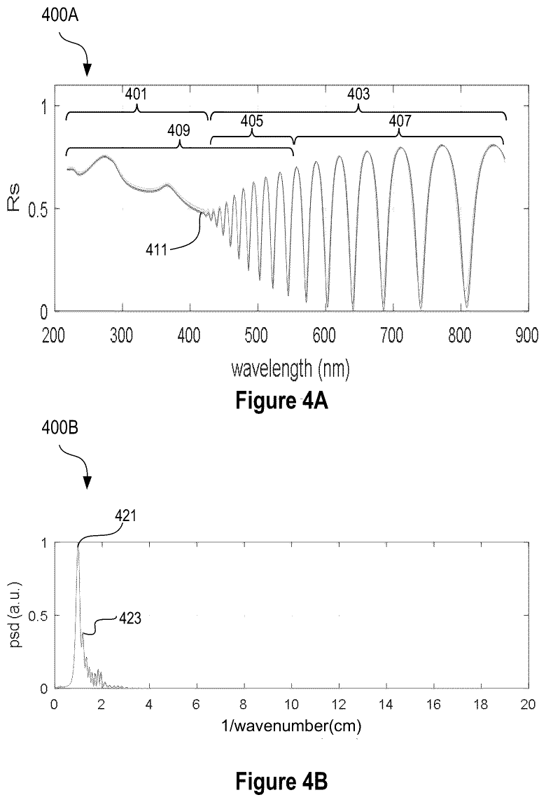

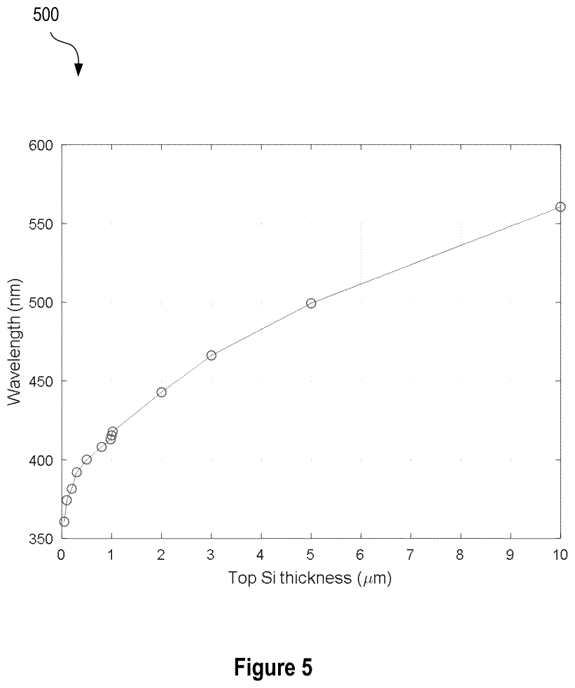

FIG. 4A can show a reflectivity spectrum 400A of a Si thin film (e.g. the top Si layer 124) without underlying structures. A wavelength at which two portions 401 and 403 of the reflectivity spectrum 400A of the top Si layer 124 meet is called the “critical wavelength” (CWL) 411. In the example of FIG. 4A, the CWL 411 is approximately 430 nm. Because absorption in Si decreases with increasing wavelength, the CWL 411 is the longest wavelength of the illumination beam at which the beam can be fully attenuated for a given thickness of the top Si layer 124. Because a thicker top Si layer allows longer wavelengths to be fully attenuated, the CWL 411 exhibits a dependence on the top Si layer thickness, as shown in a plot 500 in FIG. 5. This dependence can advantageously be used for measurement of the thickness of the top Si layer 124, and in at least one embodiment, a directly determined CWL from measured spectra can be utilized for Si layer thickness measurement, provided that the dependence of CWL versus thickness is determined, for example, experimentally or by computational methods where the experimental setup or computational model lack the underlying structures (e.g. 113).

An advantage of this measurement method is that no detailed information about the structures 113 below the top Si layer 124 is required. The disadvantage, however, is that the method may require substantial absorption within the top Si layer 124, at least in some portion of the illumination light spectrum, to ensure the existence of a CWL within the wavelength range of the broadband illumination beam.

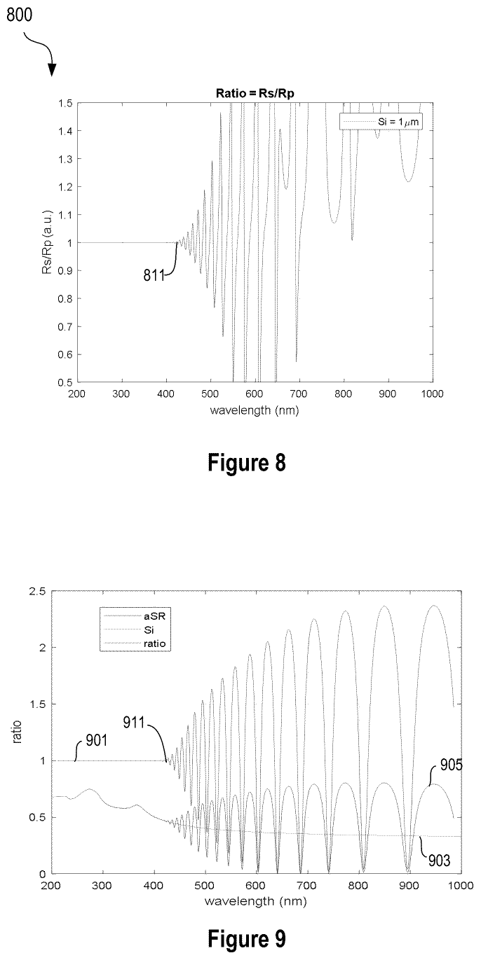

Additional processes can be used for improving the accuracy of the measured CWL, such as analyzing a ratio of acquired reflectivity spectra at two substantially orthogonal polarizations, as shown in FIG. 8, if the aSR is equipped to change the polarization orientation of the illumination beam such that two spectra at substantially orthogonal polarizations can be acquired. A point 811 where the ratio becomes different than unity is the CWL in FIG. 8. A point 911 where the ratio becomes different than unity is the CWL in FIG. 9 where plots 901, 903 and 905 respectively show a reflectivity ratio spectrum of orthogonal polarizations, a reflectivity spectrum for bare silicon, and a reflectivity spectrum for a top silicon layer on top of typical semiconductor structures on top of a Si substrate.

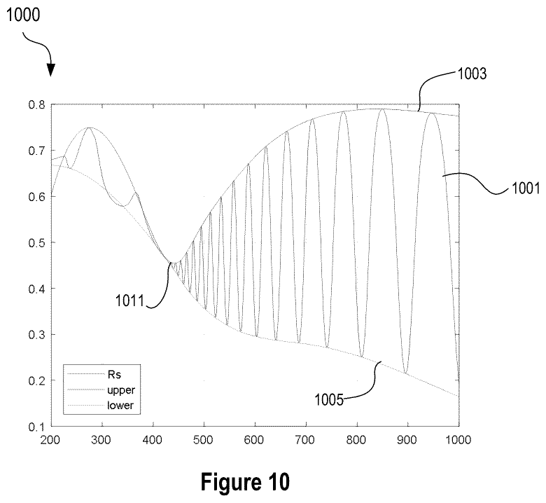

FIG. 10 shows how a CWL 1011 can be determined from a reflectivity spectrum 1000 (e.g. a reflectivity coefficient spectrum 1001 or alternatively a reflectivity ratio spectrum of different polarizations) by computing an upper envelope 1003 and a lower envelope 1005 of the reflectivity coefficient spectrum 1001 and determining the CWL 1011 where the upper envelope 1003 and the lower envelope 1005 “touch.” This method is particularly suited for thicker top Si layers whose reflectivity spectra exhibit dense small-pitch spectral periodicity.

In practice, however, further challenges are encountered due to spectral measurement noise, top and bottom surface roughness of the top Si layer 124, or a weakly defined interface (e.g. 122) between the top Si layer 124 and the (underlying) structures 113 i.e., the bonding interface, negatively affecting the portion of the illumination beam that is reflected from the bottom surface 122, and thus measured reflectivity spectra.

To overcome these challenges, in at least one embodiment, Fourier Transform (FT) can be applied to an acquired reflectivity coefficient spectrum (e.g. FIG. 4A) or a reflectivity ratio spectrum (e.g. FIG. 8) to obtain an FT spectrum 400B. Frequency analysis of the FT spectrum 400B is performed in FIG. 4B. Inventors have discovered that a primary peak 421 of the FT spectrum 400B is usually dominated by the periodicity of the reflectivity spectrum 400A at wavelengths in a portion 405 of the reflectivity spectrum 400A to the immediate right of the CWL 411. The portion 405 of the reflectivity spectrum 400A is dominated by constructive and destructive interference of the insufficiently attenuated illumination beam within the top Si layer 124. For example in FIG. 8, the measured ratio of spectra acquired at orthogonal polarizations, and with underlying structures exhibits clear periodicity in a region between the CWL (430 nm) and approximately 550 nm. The periodicity starts to be substantially altered at wavelengths longer than 550 nm by diffraction from underlying structures (e.g. 113).

In a non-limiting example, a reflectivity spectrum (e.g. 400A) can be converted to a frequency (or wavenumber) domain, including a refractive index of Si. Herein,

$$frequency = 2 \times \frac{n}{wavelength} \times {10}^{3} .$$

n represents a refractive index of Si. Frequency can have a unit of 1/μm. Wavelength can have a unit of nm. FT is performed to obtain an FT spectrum (e.g. 400B). Then, the location of the primary peak is identified with a unit of μm.

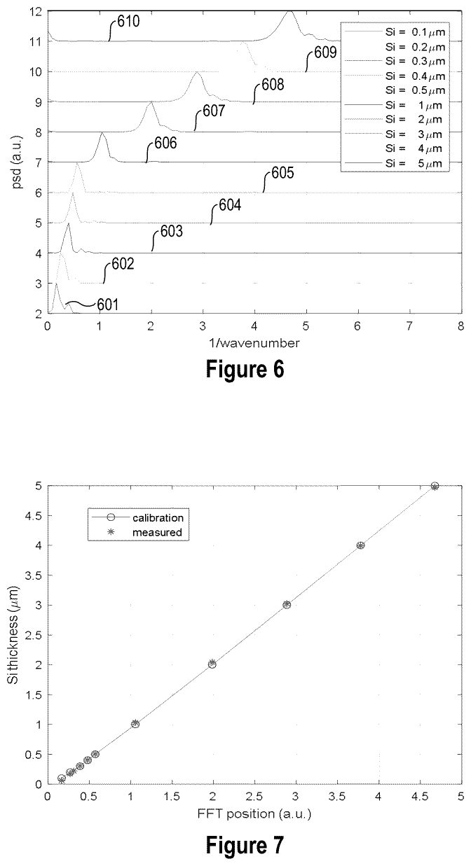

FIG. 6 shows that Fourier Transform displays a peak frequency (e.g. wavenumber) that is related to the thickness of the top Si layer 124, as is the case in thin film thickness measurements without underlying structures. Thus, using the Fourier Transform of the acquired reflectivity spectrum, it is possible to avoid explicit determination of the CWL 411, because the FT spectrum 400B is largely or substantially unaffected by the slowly changing non-oscillating portion (e.g. 401) of an acquired reflectivity spectrum at wavelengths lower than the CWL 411. At the other end, to reduce noise in the FT spectrum 400B, it may be advantageous to cut off a portion (e.g. 407) of the acquired reflectivity spectrum (e.g. 400A) where diffraction from underlying structures (e.g. 113 and 111) begins to affect the spectrum (e.g. wavelengths approximately equal to or greater than 550 nm, in FIG. 8).

However, inventors have discovered that for a wide range of cases such spectral range cut-off is not necessary, and that computing a Fourier Transform of the entire reflectivity coefficient spectrum (e.g. 400A) or the reflectivity ratio spectrum (e.g. 800) at different polarizations enables a sufficiently accurate measurement of the thickness of the top Si layer 124. This method has advantages in computational efficiency, which in turn allows a higher sampling rate and thus higher metrology throughput. Furthermore, in certain cases where attenuation in the top Si layer 124 is insufficient for the CWL 411 to be present within the wavelength range of the broadband illumination beam, the periodicity of the portion of the acquired reflectivity spectrum unaffected by underlying structures (e.g. 113) still may allow determination of the thickness of the top Si layer 124 with sufficient accuracy. However, it is preferred that the CWL 411 be present in the acquired reflectivity spectrum (e.g. 400A and 800) because that can enable a maximum wavelength range has been utilized for calculation of the Fourier Transform. It is preferred that the periodic portion (e.g. 405) of the reflectivity spectrum 400A contains enough oscillations-at a minimum of two to three, and preferably five or more, to ensure an accurate Fourier Transform peak (FT peak) calculation and thus accurate top Si layer thickness determination.

Because the attenuation and reflection of the illumination beam from the top Si layer 124 depend on complex refraction indices of Si, i.e. n and k, a different calibration (e.g. FIGS. 4 and 6) would be required for different n and/or k refraction indices of materials used for the top layer 121. In fact, n and k can vary even for the same material, e.g. Si, depending on the method and conditions for forming the top Si layer 124 (e.g. the remaining portion of the thinned bonded Si wafer). Calibrations made for particular values of n and k are very robust and reliable, in that spectral noise does not affect the FT peak and measured thickness significantly. The disadvantage is the need to create calibrations for many possible values of n and k.

To overcome the need for different calibrations for different complex refractive indices n and k, an “effective wavelength” could be used in the previously described embodiments. The “effective wavelength” incorporates n and k, and the n and k values can be factored out at the end of the calculation to determine the physical thickness of the top Si layer 124. For instance, a horizontal axis of the FT spectrum can be scaled or normalized with n and k to obtain a scaled FT spectrum. As a result, the location of the primary peak of the scaled FT spectrum is independent of n and k. Such scaling can also make the spectral response from the top Si layer 124 more periodic and thus making the primary peak more pronounced. The advantage of this method is that there is no need for multiple calibrations, but the method has a disadvantage of being more sensitive to spectral noise, which may necessitate removal of portions of the acquired spectrum such that only the portion (e.g. 405) with clear periodicity remains. Such a method is computationally more demanding because of the need to determine the spectral cut-off wavelengths.

In practice, the FT peak to thickness or “equivalent thickness” calibration of FIG. 6 could be determined using a simple computational model of reflection of a broadband illumination beam from an absorbing layer, without underlying structures. A linear fit for the FT peak vs. thickness is typically sufficient, but a higher order fitting may be employed as well. Particularly in FIG. 6, plots 601, 602, 603, 604, 605, 606, 607, 608, 609 and 610 respectively show FT spectra for the top Si layer 124 with a thickness of 0.1 μm, 0.2 μm, 0.3 μm, 0.4 μm, 0.5 μm, 1 μm, 2 μm, 3 μm, 4 μm and 5 μm. As illustrated in FIG. 7, the position of the primary peak is related to the thickness of the top Si layer 124.

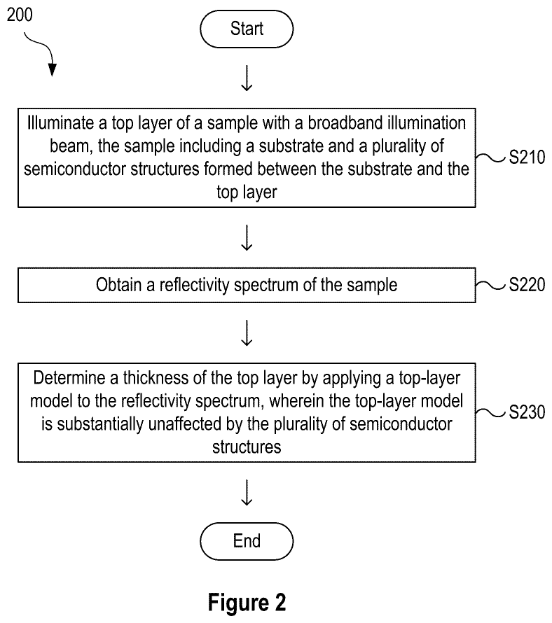

FIG. 2 shows a flow chart of a process 200 for film thickness measurements, in accordance with some embodiments of the present disclosure. At Step 210, a top layer of a sample is illuminated with a broadband illumination beam. The sample includes a substrate and a plurality of semiconductor structures formed between the substrate and the top layer. At Step S220, a reflectivity spectrum of the sample is obtained. At Step 230, a thickness of the top layer is determined by applying a top-layer model to the reflectivity spectrum. The top-layer model is substantially unaffected by the plurality of semiconductor structures.

In some embodiments, the top-layer model is a single-layer model that is affected by the top layer 121 and is substantially unaffected by the structures 113 and the substrate 111. For instance, the top-layer model may rely on information and knowledge of the top layer 121 without relying on information and knowledge of the structures 113 and the substrate 111. This is different from conventional technology where a multi-layer model is typically built to take into consideration the top layer 121 and the structures 113 (and sometimes the substrate 111 as well). That is to say, the top-layer model may include no parameter or variable related to the structures 113 and the substrate 111. Note that the top layer 121 is a single layer in many embodiments. Accordingly, the top-layer model can be a single-layer model. However, in other embodiments, the top-layer model can be applicable to a thickness-dominant layer that is below the top layer 121 or a thickness-dominant layer that is part of the top layer 121. A thickness-dominant layer can have an “effective thickness” that is much larger than those of other layers. For example, the top layer 121 can be a thin surface-roughness layer. A surface-roughness layer can for instance be the very top layer that is thin (e.g. about 3 nm) which can be modeled or treated as an effective material that contains 50% air and 50% Si. Usually, the surface-roughness layer can be ignored, but sometimes including the surface-roughness layer in the model may improve the goodness of fitting (GOF).

In a non-limiting example, applying the top-layer model includes performing a Fourier Transform (FT) of the reflectivity spectrum 400A to obtain the FT spectrum 400B and determining the thickness based on the primary peak 421 of the FT spectrum 400B which has a highest intensity in the FT spectrum 400B. For instance, a location of the primary peak 421 of the FT spectrum 400B can be calibrated as a function of the thickness of the top layer 121 experimentally and/or computationally (see e.g. FIGS. 6 and 7). Applying the “effective wavelength” approach as discussed earlier, the location of the primary peak 421 of a scaled version of the FT spectrum 400B can be independent of n and k which are complex refractive indices of the top layer 121.

Note that the FT spectrum 400B can further include at least one secondary peak 423 that is affected by the structures 113. Nevertheless, the primary peak 421 is substantially unaffected by the structures 113, and the thickness is determined based on the primary peak 421 of the FT spectrum 400B and not based on the at least one secondary peak 423. As a result, the top-layer model is substantially unaffected by the structures 113. In other words, the presence of the at least one secondary peak 423 does not affect the relationship between the location of the primary peak 421 and the thickness of the top layer 121 and is thus irrelevant to the top-layer model.

In some embodiments, one can assume that the underlying structures (e.g. 113 and 111) of each selected measurement point/region on the sample 100 is substantially the same, so their effect on the obtained thickness is substantially the same as a constant thickness offset. In some cases, this constant thickness offset is very small, so the primary peak position appears unaffected by the underlying structure. That is, the thickness determined based on the primary peak 421 may not be an absolute thickness measurement but a relative thickness instead. Nevertheless, the absolute thickness can be obtained by subtracting the constant thickness offset from the relative thickness. Therefore, one can choose to plot the absolute thickness and/or the relative thickness e.g. in FIG. 7.

In one embodiment, the FT is performed for the entire reflectivity spectrum including both a first portion 409 of the reflectivity spectrum 400A and a second portion 407 of the reflectivity spectrum 400A. The first portion 409 is substantially unaffected by the structures 113. The first portion 409 include a portion 401 below the CWL and a portion 405 dominated by constructive and destructive interference of the insufficiently attenuated illumination beam within the top layer 121. The second portion 407 is affected by the structures 113. The second portion 407 of the reflectivity spectrum 400A can show up in the FT spectrum 400B as the at least one secondary peak 423 that is irrelevant to the top-layer model.

In another embodiment, the FT is performed for only the first portion 409 which is substantially unaffected by the structures 113. Accordingly, prior to determining the thickness of the top layer 121, the second portion 407 can be truncated. In yet another embodiment, the portion 401 below the CWL 411 can be truncated from the first portion 409 to only include the portion 405 for the FT.

It should be understood that the FT does not need to be performed strictly according to

the portions divided in FIG. 4A. Instead, the FT can be performed flexibly for a wavelength range of, for example, 410-590 nm, 373-688 nm, 296-745 nm, 217-863 nm and the like. Preferably, the FT is performed for at least a wavelength range including the CWL 411 and at least two (e.g. two, three, four, five, six, seven, etc.) oscillations to the right of the CWL 411 in the reflectivity spectrum 400A. For instance, the FT can be performed for at least the portion 405, preferably at least the first portion 409, preferably the entirety of the reflectivity spectrum 400A. Moreover, it should be noted that the CWL 411 may be different depending on the material of the top layer 121 and/or the thickness of the top layer 121. Therefore, various ranges discussed herein for performing the FT are merely illustrative and not limiting.

In some embodiments, the sample 100 can be repositioned relative to the broadband illumination beam so that the top layer 121 of the sample 100 can be illuminated in a different region with the broadband illumination beam. Accordingly, another reflectivity spectrum of the sample 100 can be obtained, and therefore another thickness of the top layer 121 in the different region can be obtained by applying the top-layer model to the another reflectivity spectrum. Moreover, a plurality of thicknesses of the top layer 121 can be determined in a plurality of regions, in an X-Y pattern or an R-θ pattern, across a fraction or the entirety of the sample 100.

In the example of FIG. 4A, the reflectivity spectrum 400A shows reflectivity coefficient versus wavelength. In the example of FIG. 8, a reflectivity spectrum 800 shows a ratio of reflectivities collected at (at least) two reflected beams of substantially orthogonal polarizations. It should be understood that FT can be performed for the reflectivity spectrum 800, similarly to the reflectivity spectrum 400A. The descriptions have been provided above and will be omitted herein for simplicity purposes.

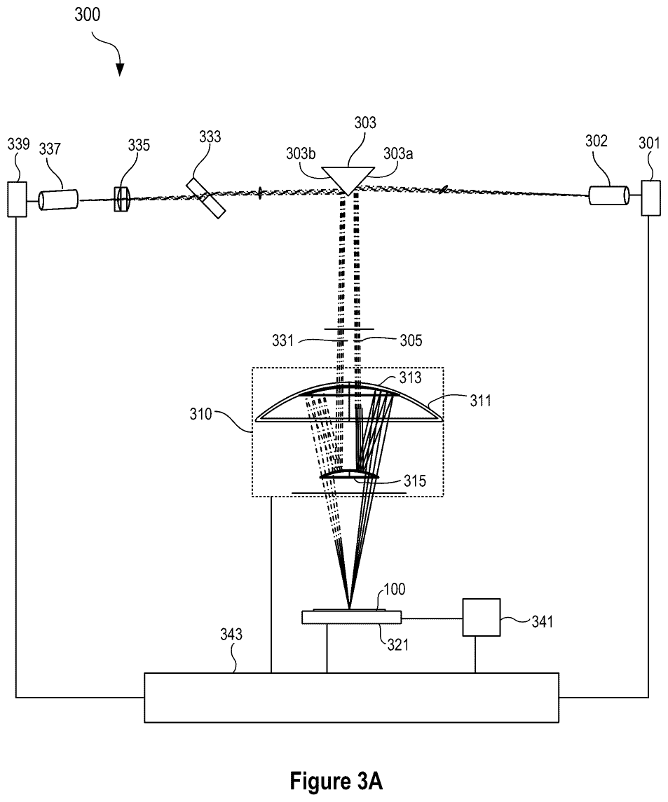

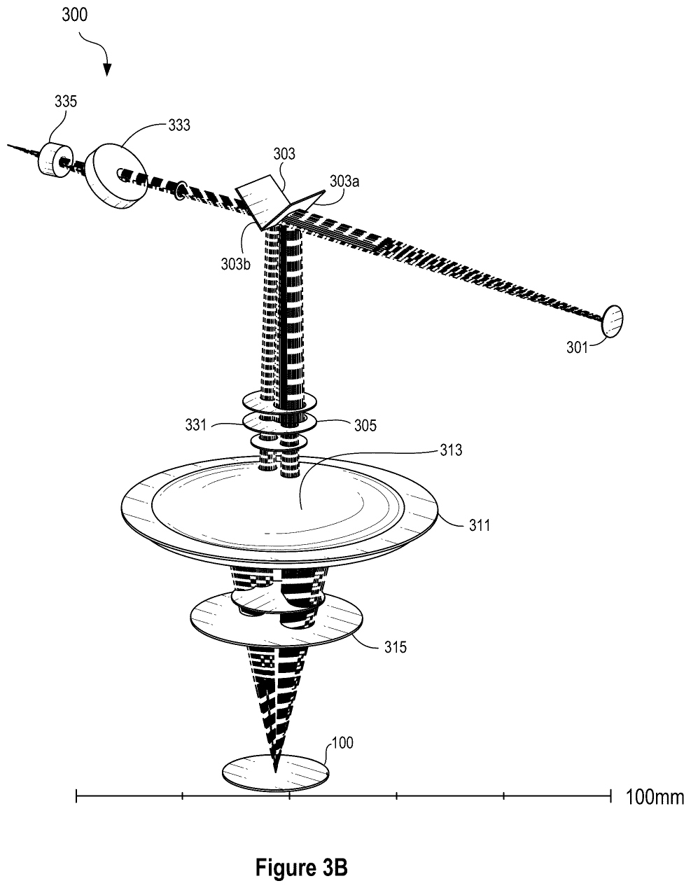

FIGS. 3A and 3B respectively show a schematic view and a perspective view of an apparatus 300 in accordance with some embodiments of the present disclosure. For example, the apparatus 300 can be used to execute the process 200 as discussed above. As shown, the apparatus 300 includes a handling stage 321 configured to receive the sample 100. A light source 301 is configured to emit a broadband illumination beam for the sample 100.

Optics are configured to guide the broadband illumination beam to illuminate the top layer 121 of the sample 100, collect a reflected beam from the top layer 121 and guide the reflected beam to an optical detector 339. Specifically, the optics can include an illumination optical fiber 302 so that the light source 301 and the illumination optical fiber 302 can function as a fiber illuminator. The optics can also include a knife edge prism (KEP) 303 having a first side 303a and a second side 303b. The optics can further include a Schwarzschild objective 310 including a primary mirror 311 and a secondary mirror 315.

In some embodiments, the primary mirror 311 can have a larger dimension than the secondary mirror 315. The primary mirror 311 has an aperture 313 (e.g. a central aperture) so that the broadband illumination beam can be directed by the first side 303a of the KEP 303 to go through the aperture 313 of the primary mirror 311 to the secondary mirror 315. The secondary mirror 315 then reflects the broadband illumination beam to the primary mirror 311 which then reflects the broadband illumination beam to the top layer 121 of the sample 100. Subsequently, a reflected beam from the top layer 121 is received by the primary mirror 311 and reflected to the secondary mirror 315. Next, the reflected beam is reflected by the secondary mirror 315 to go through the aperture 313 of the primary mirror 311 to the second side 303b of the KEP 303 which can then direct the reflected beam to the optical detector 339.

In a non-limiting example, the apparatus 300 can be configured as a spectroscopic reflectometer such as an absorption spectroscopic reflectometer (aSR). A broadband light source spanning ultraviolet (UV), visible (VIS), and near-infrared (NIR) portions of the light spectrum may be used. For example, a wavelength range of 200 to 1000 nm may be used. For certain applications, it may be necessary to extend the wavelength range further into the vacuum ultra violet (VUV) and infrared (IR) parts of the light spectrum, to accommodate thin or thick films, or films with lower-or higher-than-usual absorption. In other words, the light source 301 may be configured to illuminate the broadband illumination beam with a wavelength range defined by a lower limit and an upper limit. The lower limit can be 0.1 nm, 1 nm, 10 nm, 100 nm, 200 nm, 300 nm, 400 nm, 500 nm, 600 nm, 700 nm, 800 nm or any values therebetween. The upper limit can be 25,000 nm, 15,000 nm, 3,000 nm, 1,000 nm, 900 nm, 800 nm, 700 nm, 600 nm, 500 nm, 400 nm, 300 nm, 200 nm, 100 nm or any values therebetween.

In some embodiments, the light source 301 includes a laser-driven xenon (Xe) light source (LDLS), a laser, a laser diode, a light emitting diode, a gas discharge light source, a laser-driven light source, or any combination thereof. The light source 301 may include any suitable combination of lasers, LEDs, gas discharge light sources, etc. Preferably, the light source 301 includes an LDLS. The light source 301 may be continuous (CW) or pulsed. The broadband illumination beam is guided to the top Si layer 124 by illumination optics which may include an optical fiber (e.g. 302) to allow remote installation of the light source 301, a system stop 305, and a focusing lens (e.g. 310). The purpose of the focusing optics is to focus the illumination beam onto the top Si layer 124, with an incident angle between 0° (normal incidence) and 85°, e.g. 0°, 5°, 10°, 20°, 30°, 40°, 45°, 50°, 60°, 70°, 80°, 85° and any values therebetween. Focusing optics may include a Schwartzschild objective (e.g. 310), which uses reflective optics (e.g. 311 and 315) to focus the illumination beam. Suitable masks may be used to allow the selection of incident angle ranges for illumination or modulation of intensity levels of portions of the illumination beam with different incident angles. Upon reflection and/or refraction from the top Si layer 124, the reflected beam is formed that is captured by and transmitted by collection optics to the optical detector 339. The KEP 303 may be used to steer the illumination beam to the focusing optics (e.g. 310) and steer the reflected beam from the focusing optics (e.g. 310). The use of suitable masks allows collection of the specular reflection from the top Si layer 124, as well as scattered light in predefined reflection angle ranges. In some embodiments, the KEP 303 can be implemented in the form of two mirrors as shown in FIG. 3B.

In some embodiments, the fiber illuminator (e.g. 302 and 301) of the illumination optics is imaged via focusing optics and collection optics onto a broadband high-resolution spectrometer (e.g. 339), for measuring spectral reflectivity. The detection optics may include a system stop aperture (e.g. 331) and a collection lens (e.g. 335) for focusing the reflected beam onto an input slit or optical fiber (e.g. 337) of the spectrometer (e.g. 339). The detection optics may also include a beam splitter 333.

The collection optics may further include at least one polarizer to form a polarized reflected beam, if desired. For variation of the polarization orientation, a movable or rotatable polarizer may be used. Inventors have discovered that the use of polarization improves measurement performance when the top Si surface (e.g. 123) is not entirely smooth, due to e.g. roughness, grinding marks remaining from the process of grinding the bonded top Si wafer, etc. Inventors have also discovered that the use of polarization improves measurements when the underlying structures (e.g. 113 and 111) are highly anisotropic, or when measurements are made of wafers with substantial roughness of the Si top surface 123. The collection beam may be linearly polarized, circularly polarized, etc. In some embodiments, a polarizer may be part of the illumination optics, for example inserted into the illumination beam or integrated into the light source 301. An additional advantage of using a polarizer is that it allows the determination of the critical wavelength (CWL) as the lower bound of the periodic portion of the reflectivity spectrum, as a point where the ratio of reflectivities acquired at orthogonal polarizations deviates from unity. This allows a non-computationally intensive removal of the nonperiodic portion of the reflectivity spectra below the CWL, for determining the Fourier Transform peak (FT) with improved accuracy.

Illumination and reflected beams may have planar or circular wavefronts. In other embodiments, phase masks disposed within the illumination beam path, or reflected beam path, or both, can be used to modulate the beams across ranges of angles of incidence and reflection. For example, a 2Pi phase mask placed into the illumination beam could be used to form a circular beam with a helical wavefront. Such a beam contains an optical singularity which could advantageously be used to achieve an optimal optical power distribution within the top Si layer 124 and at the interface (e.g. 122) between the top Si layer 124 and underlying structures (e.g. 113). Additionally, as one skilled in the art would understand, a reference channel on the spectrometer (e.g. 339) may be employed to monitor the output of the light source 301, so variation in light output can be factored out of measured reflectivity spectra.

In an embodiment, the apparatus 300 is mounted on a platform which can be integrated with a wafer processing module 341. The platform may include a wafer loading apparatus and a wafer handling stage (e.g. 321) that can move and position the semiconductor wafer with respect to an optical apparatus in a way that the optical apparatus can perform multiple sequential measurements over a large portion of the wafer. The wafer handling stage may have rotational and translational degrees of freedom enabling measurements over at least 95% of the wafer surface with approximately uniform wafer coverage. Various sampling patterns may be utilized, depending on the degrees of freedom of the wafer handling stage (e.g. 321) and degrees of freedom of motion of the optical apparatus (if so equipped), such as measurements on an X-Y grid, R-θ polar grid, etc. The wafer processing module 341 can include a processing chamber configured to perform a surface treatment on the sample 100, for example in vacuum. The surface treatment includes, but is not limited to, film deposition, etching, lithographic patterning, doping, cleaning, heating, chemical-mechanical polishing, etc.

The wafer processing module 341 can include a plasma processing chamber, which may be a capacitively-coupled plasma processing chamber, inductively-coupled plasma processing chamber, microwave plasma processing chamber, Radial Line Slot Antenna (RLSATM) microwave plasma processing chamber, electron cyclotron resonance (ECR) plasma processing chamber, or other types of processing systems or combination of systems. Thus, it will be recognized by those skilled in the art that the techniques described herein may be utilized with any of a wide variety of plasma processing systems. The plasma processing chamber can be used for a wide variety of operations including, but not limited to, etching, deposition, cleaning, plasma polymerization, plasma-enhanced chemical vapor deposition (PECVD), atomic layer deposition (ALD), atomic layer etch (ALE), and the like. The structure of a plasma chamber is well known to one skilled in the art. It will be recognized that different and/or additional plasma process systems may be implemented while still taking advantage of the techniques described herein.

In some embodiments, the apparatus 300 and the platform are used to perform multiple measurements over the wafer surface with the top Si layer thickness measured at each location. The resulting set of measured thickness values is then used to interpolate over non-measured locations to generate a wafer map. The wafer map may then be transferred to the processing tool and be used by the processing tool to perform wafer processing operations that require knowledge of the top Si layer thickness distribution. In one example, the processing tool may selectively remove a portion of the top Si layer 124 to improve top Si layer thickness uniformity across the wafer. The number of measurements can vary from e.g. 5 to upwards of 100,000 measurements (e.g. 5, 50, 100, 500, 1000, 5,000, 10,000, 100,000 and any values therebetween) per wafer. High measurement densities allow detection of the “imprint” of underlying structures and die edges in the wafer map, which allow measurement points to be registered to points within individual die.

In some embodiments, the apparatus 300 can further include a controller 343. Components of the apparatus 300 can be connected to and controlled by the controller 343 that may optionally be connected to a corresponding memory storage unit and user interface (all not shown). Various processing operations (e.g. film thickness measurement operations and plasma operations) can be executed via the user interface, and various processing recipes and operations can be stored in a storage unit. Accordingly, a given substrate can be processed within the aforementioned plasma chamber with various microfabrication techniques.

It will be recognized that the controller 343 may be coupled to various components of the apparatus 300 to receive inputs from and provide outputs to the various components, including, but not limited to, the light source 301, the illumination optical fiber 302, the KEP 303, system stops 305 and 331, the Schwarzschild objective 310, the handling stage 321, the wafer processing module 341, the beam splitter 333, a collection lens 335, a collection optical fiber 337 and/or the optical detector 339. For example, the controller 343 can be configured to receive data from the optical detector 339 to determine the thickness of the top layer 121 based on the reflectivity spectrum by applying the top-layer model to the reflectivity spectrum, e.g. performing a Fourier Transform. Of course such functions can be manually accomplished as well.

The controller 343 can also be configured to adjust knobs and control settings for these components. For example, the handling stage 321 can be an X-Y, X-Y-Z, R-θ, or R-θ-Z stage, and the controller 343 can be configured to move and/or rotate the sample 100 by adjust knobs and control settings for the handling stage 321. Of course such adjustments can be manually made as well.

The controller 343 can be implemented in a wide variety of manners. In one example, the controller 343 is a computer. In another example, the controller 343 includes one or more programmable integrated circuits that are programmed to provide the functionality described herein. For example, one or more processors (e.g. microprocessor, microcontroller, central processing unit, etc.), programmable logic devices (e.g. complex programmable logic device (CPLD)), field programmable gate array (FPGA), etc.), and/or other programmable integrated circuits can be programmed with software or other programming instructions to implement the functionality of a proscribed plasma process recipe. It is further noted that the software or other programming instructions can be stored in one or more non-transitory computer-readable mediums (e.g. memory storage devices, FLASH memory, DRAM memory, reprogrammable storage devices, hard drives, floppy disks, DVDs, CD-ROMs, etc.), and the software or other programming instructions when executed by the programmable integrated circuits cause the programmable integrated circuits to perform the processes, functions, and/or capabilities described herein. Other variations could also be implemented.

The description above is provided in the context of the use of the described metrology apparatus and methods for determination of remaining thickness of a bonded semiconductor wafer. It will be understood that the same apparatus and methods are applicable to other thin film thickness measurement situations, if the film exhibits sufficient absorption of the illumination beam.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “wafer” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

The substrate can be any suitable substrate, such as a silicon (Si) substrate, a germanium (Ge) substrate, a silicon-germanium (SiGe) substrate, and/or a silicon-on-insulator (SOI) substrate. The substrate may include a semiconductor material, for example, a Group IV semiconductor, a Group III-V compound semiconductor, or a Group II-VI oxide semiconductor. The Group IV semiconductor may include Si, Ge, or SiGe. The substrate may be a bulk wafer or an epitaxial layer.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather. any limitations to embodiments of the invention are presented in the following claims.

What is claimed is:

1. A method of film thickness measurement, the method comprising:
illuminating a top layer of a sample in a first region with a broadband illumination beam, the sample including a substrate and a plurality of semiconductor structures formed between the substrate and the top layer:
obtaining a first reflectivity spectrum of the sample in the first region: and
determining a first thickness of the top layer in the first region by applying a top-layer model to the first reflectivity spectrum,
wherein the top-layer model is substantially unaffected by the plurality of semiconductor structures.

2. The method of claim 1, wherein applying the top-layer model comprises:
performing a Fourier Transform (FT) of the first reflectivity spectrum to obtain an FT spectrum: and
determining the first thickness based on a primary peak of the FT spectrum which has a highest intensity in the FT spectrum.

3. The method of claim 2, wherein:
the FT is performed for at least a first portion of the first reflectivity spectrum substantially unaffected by the plurality of semiconductor structures.

4. The method of claim 3, wherein:
the FT is performed for both the first portion and a second portion of the first reflectivity spectrum which is affected by the plurality of semiconductor structures.

5. The method of claim 4, wherein:
the FT spectrum further comprises a secondary peak that is affected by the plurality of semiconductor structures,
the primary peak is substantially unaffected by the plurality of semiconductor structures, and
the first thickness is determined based on the primary peak of the FT spectrum and not based on the secondary peak so that the top-layer model is substantially unaffected by the plurality of semiconductor structures.

6. The method of claim 3, prior to determining the first thickness of the top layer, further comprising:
truncating a second portion of the first reflectivity spectrum which is affected by the plurality of semiconductor structures.

7. The method of claim 6, further comprising:
truncating the first portion below a critical wavelength.

8. The method of claim 2, further comprising:
calibrating a location of the primary peak of the FT spectrum versus the first thickness experimentally or computationally.

9. The method of claim 8, further comprising:
scaling a horizontal axis of the FT spectrum with n and k, which are complex refractive indices of the top layer, to obtain a scaled FT spectrum so that the location of the primary peak of the scaled FT spectrum is independent of n and k.

10. The method of claim 1, wherein obtaining the first reflectivity spectrum of the sample comprises:
collecting at least two reflected beams of substantially orthogonal polarizations; and
obtaining the first reflectivity spectrum as a ratio of reflectivities collected at the at least two reflected beams.

11. The method of claim 10, further comprising:
determining a critical wavelength at which the ratio starts to be different from unity.

12. The method of claim 1, wherein the first reflectivity spectrum of the sample is a reflectivity coefficient spectrum, the method further comprising:
determining a critical wavelength which is a boundary between two regimes of the reflectivity coefficient spectrum.

13. The method of claim 1, further comprising:
repositioning the sample, the broadband illumination beam, or a combination thereof:
illuminating the top layer of the sample in a second region with the broadband illumination beam:
obtaining a second reflectivity spectrum of the sample in the second region; and
determining a second thickness of the top layer in the second region by applying the top-layer model to the second reflectivity spectrum.

14. The method of claim 13, further comprising:
determining a plurality of thicknesses of the top layer in a plurality of regions, in an X-Y pattern or an R-θ pattern, across at least a fraction of the sample.

15. The method of claim 1, wherein:
the top layer comprises a semiconductor material, and
the broadband illumination beam has a wavelength range of 200-1000 nm.

16. An apparatus, comprising:
a handling stage configured to receive a sample, the sample comprising a substrate, a top layer and a plurality of semiconductor structures formed between the substrate and the top layer:
a light source configured to emit a broadband illumination beam:
optics configured to guide the broadband illumination beam to illuminate the top layer of the sample, collect a reflected beam from the top layer and guide the reflected beam to an optical detector that is configured to obtain a reflectivity spectrum of the sample: and
a controller configured to determine a thickness of the top layer by applying a top-layer model to the reflectivity spectrum,
wherein the top-layer model is substantially unaffected by the plurality of semiconductor structures.

17. The apparatus of claim 16, wherein the optics comprise a Schwarzschild objective and a knife edge prism (KEP), wherein:
the Schwarzschild objective includes a primary mirror and a secondary mirror,
the KEP has a first side and a second side,
the Schwarzschild objective and the KEP are configured so that the broadband illumination beam is directed by the first side of the KEP to go through an aperture of the primary mirror to the secondary mirror, reflected to the primary mirror, and then reflected to the top layer of the sample, and
the Schwarzschild objective and the KEP are configured so that the reflected beam from the top layer is reflected by the primary mirror to the secondary mirror, reflected to go through the aperture of the primary mirror to the second side of the KEP, and then directed to the optical detector.

18. The apparatus of claim 16, wherein:
the optics includes at least one selected from the group consisting of an optical fiber, a collection lens, a system stop aperture, and a polarizer.

19. The apparatus of claim 16, wherein:
the handling stage is an X-Y, X-Y-Z, R-θ, or R-θ-Z stage, and
the light source includes at least one selected from the group consisting of a laser, a laser diode, a light emitting diode, a gas discharge light source, and a laser-driven light source.

20. The apparatus of claim 16, further comprising:
a processing chamber configured to perform a surface treatment on the sample.
